(19) United States
(12) Patent Application Publication
(10) Pub. No.: US 2017/0170547 A1
(43) Pub. Date: Jun. 15, 2017

(54) ULTRA-WIDE-BAND PARASITIC ANTENNA AND MOBILE TERMINAL

(71) Applicants: LE HOLDINGS (BEIJING) CO., LTD., Beijing (CN); Lemobile Information Technology (Beijing) Co., Ltd, Beijing (CN)

(72) Inventors: Lishan HUANG, Beijing (CN); Niantao WANG, Beijing (CN)

(21) Appl. No.: 15/236,338

(22) Filed: Aug. 12, 2016

Related U.S. Application Data
(63) Continuation of application No. PCT/CN2016/088890, filed on Jul. 6, 2016.

(30) Foreign Application Priority Data
Dec. 15, 2015 (CN) 201510939736.X

(51) Int. Cl. H01Q 1/24; H01Q 1/36; H01Q 1/48

(52) U.S. Cl. CPC H01Q 1/243; H01Q 1/48; H01Q 1/36

(57) ABSTRACT

An embodiment of the present disclosure discloses an ultra-wide-band parasitic antenna and a mobile terminal. The antenna comprises an antenna feed unit, an antenna grounding unit and an antenna radiation part which are disposed on an antenna bracket, a first parasitic antenna resonance part disposed on the antenna bracket and connected with the antenna radiation part, a second parasitic antenna resonance part disposed out of the antenna bracket, wherein the second parasitic antenna resonance part and the antenna radiation part in a coupled relationship. The ultra-wide-band parasitic antenna and the mobile terminal provided by the embodiment of the present disclosure save antenna design space for the mobile terminal, save project cost and avoid consumption.

### CROSS-REFERENCE TO RELATED APPLICATIONS

This application is a continuation of International Application No. PCT/CN2016/088890, filed on Jul. 6, 2016, which claims priority to Chinese Patent Application No. 201510939736.X, entitled “ULTRA-WIDE-BAND PARASITIC ANTENNA AND MOBILE TERMINAL”, filed Dec. 15, 2015, the entire contents of all of which are incorporated herein by reference.

### FIELD OF TECHNOLOGY

The present disclosure generally relates to antenna technologies, in particular to an ultra-wide-band parasitic antenna and a mobile terminal.

### BACKGROUND

Along with the increase in users of mobile terminals and rise in a ratio of smart mobile phones, rapid development of LTE (Long Term. Evolution) drives mobile terminals to upgrade faster and faster. Mobile phone antenna as a very important non-standard constitutional component of a mobile phone constrains the overall performance of wireless transmission of the mobile phone. At present, traditional mobile phone antennas fail to meet requirements of wireless communication of LTE. Small-sized mobile phone antennas with an ultra-wide-band have become a research hot spot of the current communication industry. Therefore, the mobile phone's development trend to small size, multi-frequency and wide-band has great research significance.

Due to fast development of LTE, many mobile phone antennas are required to cover 698 MHz-960 MHZ and 1710 MHz-2700 MHz.

At present, in the prior art, many mobile antennas in different frequency bands expand the antenna frequency band through a switch or a tuner, thereby achieving a wide frequency band.

However, such solution has the following disadvantages:

in this way, the consumption of import varies with the placement, match, layout, etc. of devices. Therein, radio frequency, antenna and PCB (Printed Circuit Board) engineers are needed to estimate the optimal position and wiring in the pre-stage advanced search. If the design is poor, the consumption of import will exceed the advantages brought by the switch or turner.

Therefore, how to provide a novel antenna design, which meets wide-band requirements, is a technical problem urgently to be solved.

### SUMMARY

An embodiment of the present disclosure discloses an ultra-wide-band parasitic antenna and a mobile terminal to overcome the defect of much power consumption caused by importing a large device such as a switch or a tuner to realize expansion of the antenna frequency band, realize a novel antenna design solution meeting wide-band requirements, save antenna space of the mobile terminal and reduce power consumption caused by increase in components.

In order to solve the above problems, an embodiment of the present disclosure discloses an ultra-wide-band parasitic antenna, comprising:

an antenna feed unit, an antenna grounding unit and an antenna radiation part which are disposed on an antenna bracket;

a first parasitic antenna resonance part disposed on the antenna bracket and connected with the antenna radiation part;

a second parasitic antenna resonance part disposed out of the antenna bracket;

wherein, the second parasitic antenna resonance part and the antenna radiation part are in a coupled relationship.

In the ultra-wide-band parasitic antenna and the mobile terminal provided by the embodiment of the present disclosure, the parasitic antenna resonance part is respectively disposed on the antenna bracket and the PCB in an innovative way, not only saving antenna design space for the mobile terminal, but also saving project cost and avoiding consumption. Besides, the parasitic antenna has low requirements for thickness and therefore is very applicable to terminals with requirements for antenna thickness.

### BRIEF DESCRIPTION OF THE DRAWING

To clearly describe the technical solution in the embodiments of the present disclosure or in the prior art, the following are brief introduction of the attached drawings used to describe the technology in the embodiments or in the prior art. Obviously, the attached drawings described below involve some embodiments of the present disclosure. For a person skilled in the art, other drawings can be made according to those drawings without creative labor.

FIG. 1 is a structural view of an antenna bracket according to an embodiment of the present disclosure.

FIG. 2 is a structural view of an antenna bracket and a parasitic antenna on a PCB according to an embodiment of the present disclosure.

FIG. 3 is a consumption diagram of an actually measured wave of an ultra-wide-band parasitic antenna according to the present disclosure.

FIG. 4 is an actually measured efficiency diagram of an ultra-wide-band parasitic antenna according to the present disclosure.

### DESCRIPTION OF THE EMBODIMENTS

To clarify the objectives, technical solutions and advantage of the embodiments of the present disclosure, the technical solutions in embodiments of the present disclosure are clearly and completely described below with reference to drawings in the embodiments of the present disclosure. Obviously, the described embodiments are some embodiments of the present disclosure, not the embodiments of the present disclosure, Based on the embodiments in the present disclosure, a person skilled in the art can obtain other embodiments without creative labor, which shall fall within the protection scope of the present disclosure.

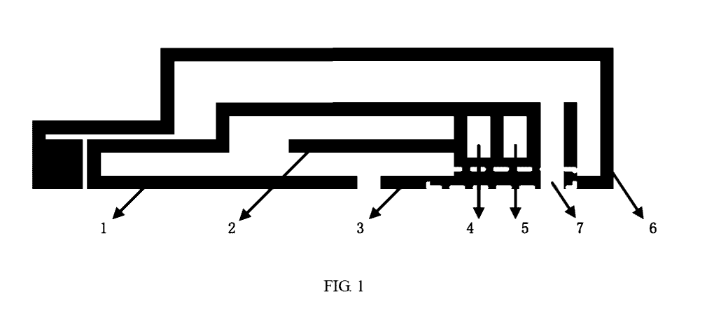

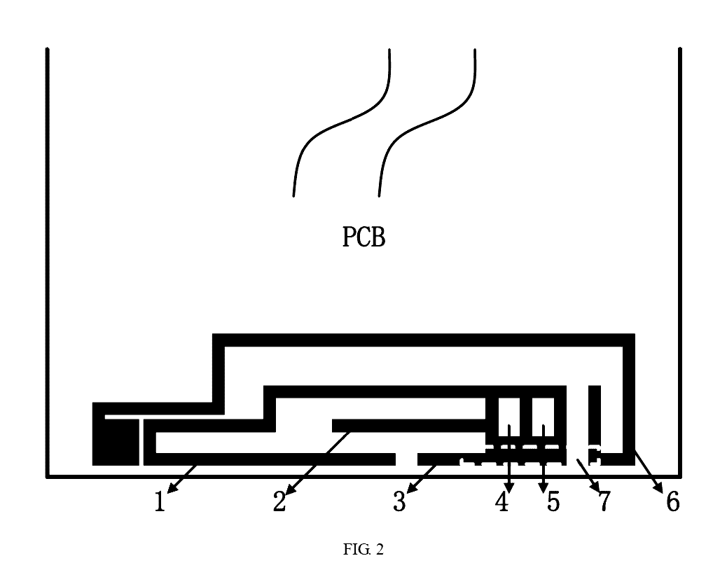

Refer to FIG. 1 and FIG. 2, which illustrate structural views of an ultra-wide-band antenna according to an embodiment of the present disclosure, wherein FIG. 1 is a structural block diagram of an antenna bracket according to an embodiment of the present disclosure, and FIG. 2 is a structural view of an antenna bracket and a parasitic antenna on a PCB according to an embodiment of the present disclosure.

An ultra-wide-band parasitic antenna includes an antenna feed unit 4, an antenna grounding unit 5 and an antenna radiation part which are disposed on an antenna bracket, a first parasitic antenna resonance part 6, namely a low-frequency parasitic antenna resonance part, disposed on the antenna bracket and connected with the antenna radiation part, and a second parasitic antenna resonance part 7, namely a high-frequency parasitic antenna resonance part, disposed out of the antenna bracket, as shown in the dotted-line portions in FIG. 1 and FIG. 2, disposed on a PCB (Printed Circuit Board), wherein the second parasitic antenna resonance part 7 and the antenna radiation part in a coupled relationship. Wherein, the antenna bracket, and the antenna feed unit 4, the antenna grounding unit 5 and the antenna radiation part disposed thereon as well as the first parasitic antenna resonance part 6 are correspondingly assembled above the second parasitic antenna resonance part 7.

In this embodiment, the antenna radiation part includes at least one branch, and each branch includes at least one radiation arm.

As shown in FIG. 1 and FIG. 2, the antenna radiation part includes three branches, a first branch 1, a second branch 2 and a third branch 3, each branch including one radiation arm; wherein, the first branch 1 is used for generating 900 MHz resonance; the second branch 2 and the third branch 3 are used for generating 1,700 MHz and 1,900 MHz high-frequency resonance; the second branch 2 and the third branch 3 are mutually coupled with the first branch 1; the first parasitic antenna resonance part 6 generates 698 MHz resonance; and the second parasitic antenna resonance part 7 generates 2,700 MHz resonance. The resonance generated by the first branch 1, the second branch 2, the third branch 3, the first parasitic antenna resonance part 6 and the second parasitic antenna resonance part 7 mentioned in this embodiment is one embodiment of the present disclosure. The present disclosure does not limit in the resonance frequencies listed in this embodiment. Specific resonance frequency values or scopes can vary with the design requirements or pattern solutions of specific terminal antennas, and the present disclosure does not need to set a limit.

In this embodiment, the antenna bracket is made from plastics; and the antenna feed unit 4, the antenna grounding unit 5, the antenna radiation part, the first parasitic antenna resonance part 6 and the second parasitic antenna resonance part 7 all are made from metal materials.

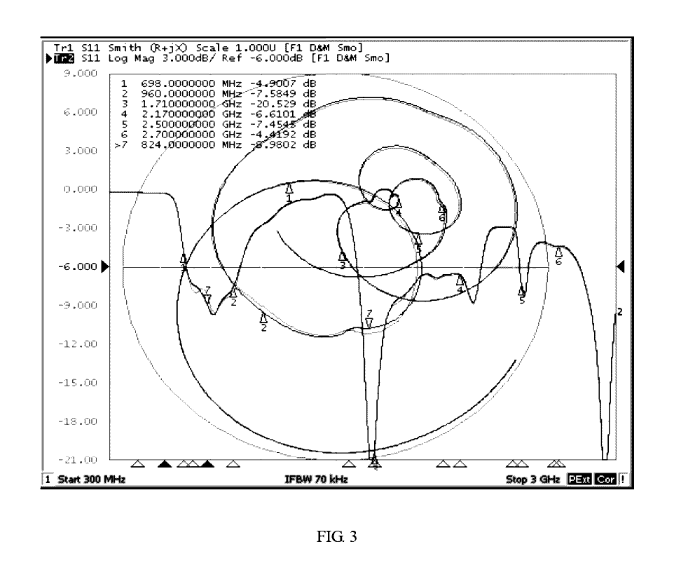

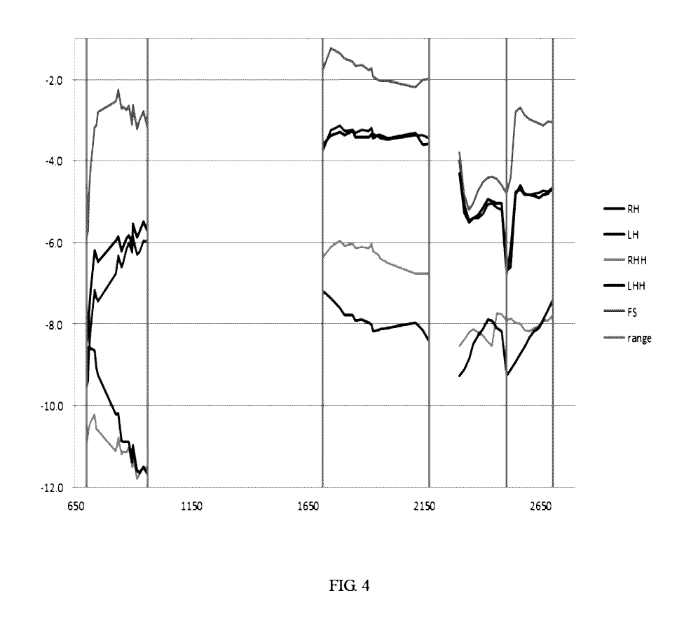

According to the embodiments in FIG. 1 and FIG. 2, after actual commissioning, the actually measured echo consumption diagram of the actually commissioned ultra-wide-band parasitic antenna (horizontal ordinates represent frequencies, in unit of MHz, and vertical ordinates represent antenna echo consumption, in unit of dB) and the efficiency of the ultra-wide-band parasitic antenna as shown in FIG. 3 and FIG. 4, are obtained. From the commissioning results, it can be seen that, the wide-band of the ultra-wide-band parasitic antenna in the embodiment can completely meet the ultra-wide-band requirements of 698 MHz-960 MHz and 1710 MHz-2700 MHz.

In the present disclosure, through the low-frequency parasitic antenna disposed on the antenna bracket and the high-frequency parasitic antenna disposed on the PCB, the antenna of this embodiment technically meets the wide-band requirements of the mobile terminals such as mobile phones without using external adjustable elements, not only saving antenna design space in the mobile terminal, but also saying cost and avoiding consumption. Besides, the parasitic antenna has low requirements for thickness and therefore is very applicable to terminals with requirements for antenna thickness.

Likewise, the ultra-wide-band parasitic antenna in the embodiment can be designed in a mobile terminal, for example a mobile phone; the low-frequency parasitic antenna is disposed in the antenna bracket of the mobile phone, equivalent to the first parasitic antenna resonance part 6 as shown in FIG. 1 and FIG. 2; and the high-frequency parasitic antenna is disposed on the PCB of the mobile phone, equivalent to the second parasitic antenna resonance part 7 as shown in FIG. 1 and FIG. 2. The principle and effects are identical with those of the embodiment as shown in FIG. 1 and FIG. 2, and are not repeated here.

The device embodiments described above are schematic only, wherein units described as separate components can be or cannot be separated physically; components which are adopted as display units display can be or cannot be physical units, namely located on a place or distributed to a plurality of network units. The purpose of the schemes in the embodiment can be achieved via partial or all modules according to actual requirements. A person skilled in the art can understand and implement without creative labor.

Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. An ultra-wide-band parasitic antenna, comprising:
an antenna feed unit, an antenna grounding unit and an antenna radiation part which are disposed on an antenna bracket;
a first parasitic antenna resonance part disposed on the antenna bracket and connected with the antenna radiation part;
a second parasitic antenna resonance part disposed out of the antenna bracket;
wherein, the second parasitic antenna resonance part and the antenna radiation part are in a coupled relationship.

2. The antenna according to claim 1, wherein,
the first parasitic antenna resonance part is a low-frequency parasitic antenna resonance part;
and the second parasitic antenna resonance part is a high-frequency parasitic antenna resonance part.

3. The antenna according to claim 1, wherein,
the second parasitic antenna resonance part is disposed on a PCB below the antenna bracket;
the antenna bracket, and the antenna feed unit, the antenna grounding unit and the antenna radiation part disposed thereon as well as the first parasitic antenna resonance part are correspondingly assembled above the second parasitic antenna resonance part.

4. The antenna according to claim 1, wherein,
the antenna radiation part comprises at least one branch, and each branch comprises at least one radiation arm.

5. The antenna according to claim 1, wherein,
the antenna radiation part comprises three branches, and each branch comprises one radiation arm;
a first branch is used for generating 900 MHz resonance; a second branch and a third branches are used for generating 1,700 MHz and 1,900 MHz high-frequency resonance;
the second branch and the third branch are mutually coupled with the first branch;
the first parasitic antenna resonance part generates 698 MHz resonance;
and the second parasitic antenna resonance part generates 2,700 MHz resonance;

6. The antenna according to claim 1, wherein,
the antenna bracket is made from plastics;
and the antenna feed unit, the antenna grounding unit, the antenna radiation part, the first parasitic antenna resonance part and the second parasitic antenna resonance part all are made from metal materials.

7. A mobile terminal with an ultra-wide-band parasitic antenna, comprising an antenna system, wherein, the antenna system comprises:
an antenna feed unit, an antenna grounding unit and an antenna radiation part which are disposed on an antenna bracket;
a first parasitic antenna resonance part disposed on the antenna bracket and connected with the antenna radiation part;
a second parasitic antenna resonance part disposed out of the antenna bracket;
wherein, the second parasitic antenna resonance part and the antenna radiation part are in a coupled relationship.

8. The mobile terminal according to claim 7, wherein,
the first parasitic antenna resonance part is a low-frequency parasitic antenna resonance part;
and the second parasitic antenna resonance part is a high-frequency parasitic antenna resonance part.

9. The mobile terminal according to claim 7, wherein,
the second parasitic antenna resonance part is disposed on a PCB below the antenna bracket;
the antenna bracket, and the antenna feed unit, the antenna grounding unit and the antenna radiation part disposed thereon as well as the first parasitic antenna resonance part are correspondingly assembled above the second parasitic antenna resonance part.

10. The mobile terminal according to claim 7, wherein,
the antenna radiation part comprises at least one branch, and each branch comprises at least one radiation arm.

11. The mobile terminal according to claim 7, wherein,
the antenna radiation part comprises three branches, and each branch comprises one radiation arm;
a first branch is used for generating 900 MHz resonance; a second branch and a third branches are used for generating 1700 MHz and 1,900 MHz high-frequency resonance;
the second branch and the third branch are mutually coupled with the first branch;
the first parasitic antenna resonance part generates 698 MHz resonance;
and the second parasitic antenna resonance part generates 2,700 MHz resonance;

12. The mobile terminal according to claim 7, wherein,
the antenna bracket is made from plastics;
and the antenna feed unit, the antenna grounding unit, the antenna radiation part, the first parasitic antenna resonance part and the second parasitic antenna resonance part all are made from metal materials.
